(19) United States
(12) Patent Application Publication
(10) Pub. No.: US 2020/0034487 A1
(43) Pub. Date: Jan. 30, 2020

(54) Method of Implementing A Topic Based Social Media Network

(71) Applicant: James C. Hernandez, Pasadena, MD (US)

(72) Inventor: James C. Hernandez, Pasadena, MD (US)

(21) Appl. No.: 16/048,040

(22) Filed: Jul. 27, 2018

(51) Int. Cl. G06F 17/30; G06Q 30/02; H04L 29/08

(52) U.S. Cl. CPC G06F 17/30867; G06F 17/30876; G06Q 50/01; H04L 67/303; G06Q 30/0245

(57) ABSTRACT

A method of implementing a topic based social media network provides a server configured to store, manage, and display a plurality of topics. Users interacting with the server are assigned a unique user identifier as a digital avatar, and users may select a relationship qualifier for themselves in relation to specific topics and interact with other users based on their respective relationship qualifiers with the topics.

### FIELD OF THE INVENTION

The present invention relates generally to electronic communication among individuals. More particularly, the present invention relates to a social network for connecting users based on various topics.

### BACKGROUND OF THE INVENTION

Privacy is the ability of an individual or group to seclude themselves, or information about themselves, and thereby express themselves selectively. The boundaries and content of what is considered private differ among cultures and individuals but share common themes. When something is private to a person, it usually means that something is inherently special or sensitive to them. The domain of privacy partially overlaps security (confidentiality), which can include the concepts of appropriate use, as well as protection of information. Privacy may also take the form of bodily integrity.

Internet privacy involves the right or mandate of personal privacy concerning the storing, repurposing, provision to third parties, and displaying of information pertaining to oneself via of the Internet. Internet privacy is a subset of data privacy. Privacy concerns have been articulated from the beginnings of large scale computer sharing.

Privacy can entail either Personally Identifying Information (PII) or non-PII information such as a site visitor's behavior on a website. PII refers to any information that can be used to identify an individual. For example, age and physical address alone could identify who an individual is without explicitly disclosing their name, as these two factors are unique enough to typically identify a specific person.

Companies are often hired to collect data on what Internet sites people visit and how they interact with the sites. There are many ways in which people can divulge their personal information, for instance by use of “social media” and by sending bank and credit card information to various websites. Moreover, directly observed behavior, such as browsing logs, search queries, or contents of the social media profile can be automatically processed to infer potentially more intrusive details about an individual, such as sexual orientation, political and religious views, race, substance use, intelligence, and personality. Further, even without any historical behavioral data, there are a large number of insights which can be generated solely by tracking onsite user interaction like post code, name and local address.

A data breach is the intentional or unintentional release of secure or private/confidential information to an untrusted environment. By definition, a data breach is a security incident in which sensitive, protected or confidential data is copied, transmitted, viewed, stolen or used by an individual unauthorized to do so. Data breaches may involve financial information such as credit card or bank details, personal health information (PHI), Personally identifiable information (PII), trade secrets of corporations or intellectual property. Most data breaches involve overexposed and vulnerable unstructured data—files, documents, and sensitive information.

According to the nonprofit consumer organization Privacy Rights Clearinghouse, a total of 227,052,199 individual records containing sensitive personal information were involved in security breaches in the United States between January 2005 and May 2008, excluding incidents where sensitive data was apparently not actually exposed.

Clearly, it is desirable to protect one's privacy in general, but in particular in conjunction with one's use of the Internet, where the average user may not be aware of the various means of collecting their data unawares. Various topics of discussion are sensitive and confidential, such that people may benefit from utilizing digital avatars to protect their reputation, business, community standing, and more in relation to such topics as addition recovery, gender identity, marital relations, and many others.

It is therefore an objective of the present invention to provide a topic-based social networking platform that protects users from data breaches by using digital avatars as a buffer between the user and their online experience, wherein users may communicate with each other based on various topics.

### BRIEF DESCRIPTION OF THE DRAWINGS

FIG. 1 is a general illustrative description of the present invention.

FIG. 2 is an exemplary diagram illustrating potential interactions between users based on topics.

FIG. 3 is a stepwise flow diagram showing the general steps of the method of the present invention.

FIG. 4 is a stepwise flow diagram showing various aspects of the present invention in accordance with some embodiments.

FIG. 5 is a stepwise flow diagram showing steps for adding new topics and sub-topics in accordance with some embodiments.

FIG. 6 is a stepwise flow diagram showing steps for implementing surveys with topics in accordance with some embodiments.

FIG. 7 is a stepwise flow diagram showing steps for implementing media items with topics in accordance with some embodiments.

FIG. 8 is a stepwise flow diagram showing steps for implementing event items with topics in accordance with some embodiments.

FIG. 9 is a stepwise flow diagram showing steps for implementing personal topics for users in accordance with some embodiments.

### DETAIL DESCRIPTIONS OF THE INVENTION

All illustrations of the drawings are for the purpose of describing selected versions of the present invention and are not intended to limit the scope of the present invention. The present invention is to be described in detail and is provided in a manner that establishes a thorough understanding of the present invention. There may be aspects of the present invention that may be practiced or utilized without the implementation of some features as they are described. It should be understood that some details have not been described in detail in order to not unnecessarily obscure focus of the invention. References herein to “the preferred embodiment”, “one embodiment”, “some embodiments”, or “alternative embodiments” should be considered to be illustrating aspects of the present invention that may potentially vary in some instances and should not be considered to be limiting to the scope of the present invention as a whole.

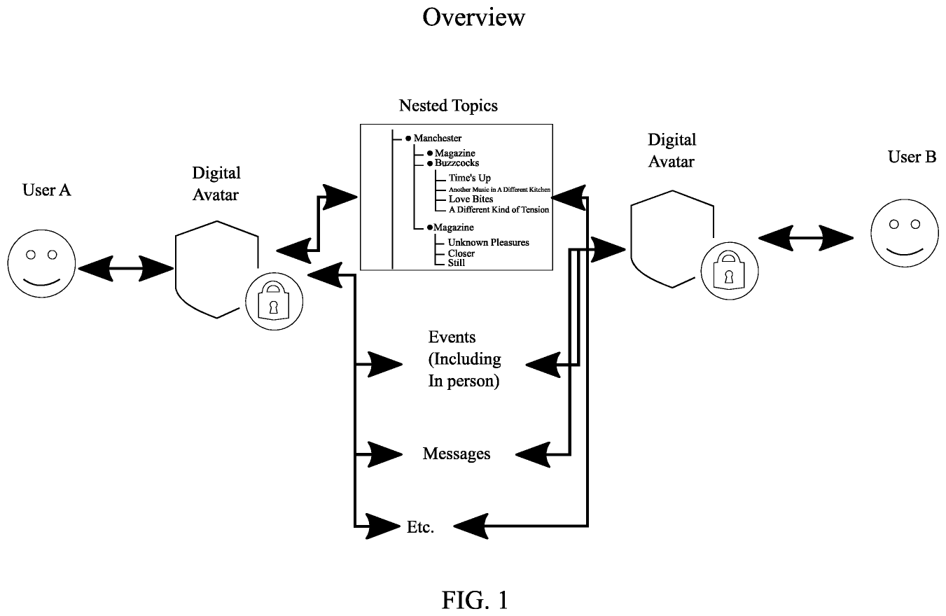

The present invention is a social networking platform focused on electronically creating connections, or “bridges,” between people based on their interest in particular topics. More specifically, the present invention is a method of implementing a topic based social media network. FIG. 1 shows a general illustrative diagram of the present invention.

The present invention is focused on creating a space where users may connect with each other through common interests, while the users' personal information is simultaneously protected. The core idea of the present invention is that users may interact with other users utilizing the present invention, preferably embodied as a social media platform on the Internet, through digital avatars. Each individual user's information is protected from data breaches, as the digital avatars provide anonymous identification for users. Each user has a unique identifier through which they interface with the present invention. It may be noted that unique identifiers and digital avatars may in some instances and in some embodiments be used interchangeably or may be separate entities. Users, through their digital avatars, interact with other users through the medium of topics. The subject of the topic may vary, not being limited in scope. Any subject desired to be discussed or otherwise interacted with may be facilitated through the present invention, albeit in some embodiments through the discretion and moderation of administrators or other designated moderation personnel. The digital avatars of the present invention provide several benefits: provide login credentials, safeguard online privacy, and protect against user data breaches. A digital avatar acts as a gatekeeper between a user's public face and privacy information. A digital avatar may be embedded into a barcode or QR code in order to provide personal data protection for in person physical meetings between users. The specific nature of the digital avatars utilized in the present invention may vary as appropriate or desired.

In the preferred embodiment of the present invention, topics of discussion and other interaction between users may be nested. Thus, topics may comprise a hierarchical structure of topics, beginning at high level, general subjects such as “Music,” “Home Life,” “Entertainment” and the like, down to more specific sub-topics, such as, respectively, “Classic Rock,” “Gardening,” and “Concerts.”

The nested topic centric nature of the social network of the present invention allows users to communicate, do business, and coordinate activities using digital avatars as opposed to their real email addresses or other real personally identifiable information (PII). The present invention allows users to discuss sensitive topics without fear or embarrassment, shame, defamation, or harm. The present invention is intended to provide “bridges” of communication between people without fear or embarrassment.

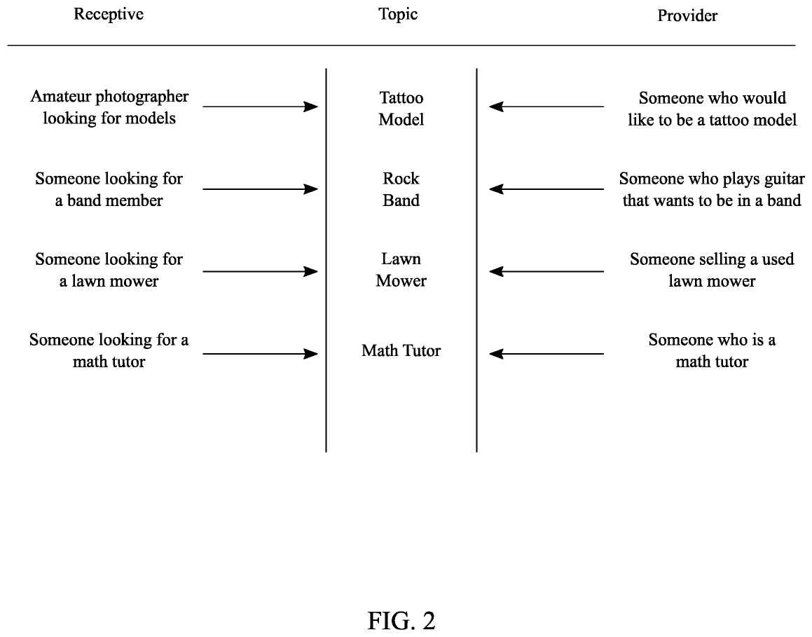

In the preferred embodiment, users, protected by their digital avatars, may mark their interest in any given topic as one of a plurality of statuses indicating their desired relationship with a topic. For example, in some embodiments, users may mark themselves with a “receptive” status” or a “provider” status with a specific topic. FIG. 2 shows a general illustration of users being able to mark themselves as receptive or providers for various topics. Continuing the example, someone looking to acquire a lawn mower may mark themselves as “receptive” to a topic of category “Lawn mowers,” while a user interested in selling or giving away a lawn mower may mark themselves with a “provider” status for the “Lawn mowers” topic. Further, direct marketing can specifically target real users (through their digital avatars) based on their interest in a topic. Marketing efforts may no longer be required to distribute advertisements to general audiences of all ages and interests. Furthermore, the preferred embodiment of the present invention will include an inappropriate content reporting system. The inappropriate content reporting system may vary in nature, but in general should be used to instantly or through a review process block offensive or unlawful postings and topics.

Essentially, the present invention begins with topics. In various embodiments, topics may be unlimited in scope. Any subject desired to be discussed may be initiated as a topic. In some embodiments, topics may be subject to various guidelines, such as, but not limited to, legality and offensiveness standards. Some examples of potential topics may include but are not limited to: Tattoo Model; Rock Band; Lawn Mower; Math Tutor. After a topic is created, users may express their interest in a given topic by marking their desired relationship to a topic. For example, an amateur photographer looking for models may mark themselves as receptive to the Tattoo Model topic. A user who plays guitar and wishes to join a band may mark themselves as with a provider status to the Rock Band topic. Someone selling a used lawn mower may mark themselves with a provider status to the Lawn Mower topic. Someone looking for a math tutor may mark themselves as receptive to the Math Tutor topic.

Conversely, a user who would like to be a tattoo model may mark themselves as a provider in relationship to the Tattoo Model topic. Someone looking for a band member may mark themselves as receptive to the Rock Band topic. Someone looking for a lawn mower may mark themselves receptive to the Lawn Mower Topic. Someone who is a math tutor may mark themselves as a provider for the Math Tutor topic.

The previously disclosed examples should not be considered to be limiting to the present invention. Any subject may be included, such as, but not limited to, sports, clubs, local businesses, social causes, or community. However, it may be noted that subjects which are deemed illegal, immoral, offensive, or otherwise undesirable may be prohibited.

It is further desired in the preferred embodiment that topics may be nested in a hierarchical structure for clarity, from general at the highest level to more specific further down in the hierarchical structure. For example, under the general topic of “Sports,” the sub-topics “Football,” “Baseball,” and “Basketball” may be nested. In another example, sub-topics such as “Auto Service,” “Restaurants,” and “Law Services” may be nested under the general topic of “Local Businesses.” For example, under the “Auto Service” topic, further nested topics may include “Foreign Auto Service,” “Oil Change,” and “Window Repair.” In some embodiments, topics may be for all intents and purposes capable of being infinitely nested. In some embodiments, the number of subordinate nested levels below any given topic may be limited to a specified number.

Behind online digital avatars, or physically bearing barcodes, QR codes or similar containing their digital avatar identification information, users may do the following without having to use their own personal email addresses, accounts, names, addresses, etc. while protecting their privacy and personal information: meet in person; communicate; show an interest in a topic as “receptive,” provider,” or both; scan identifiable codes of user users of the present invention in order to communicate with them, and more.

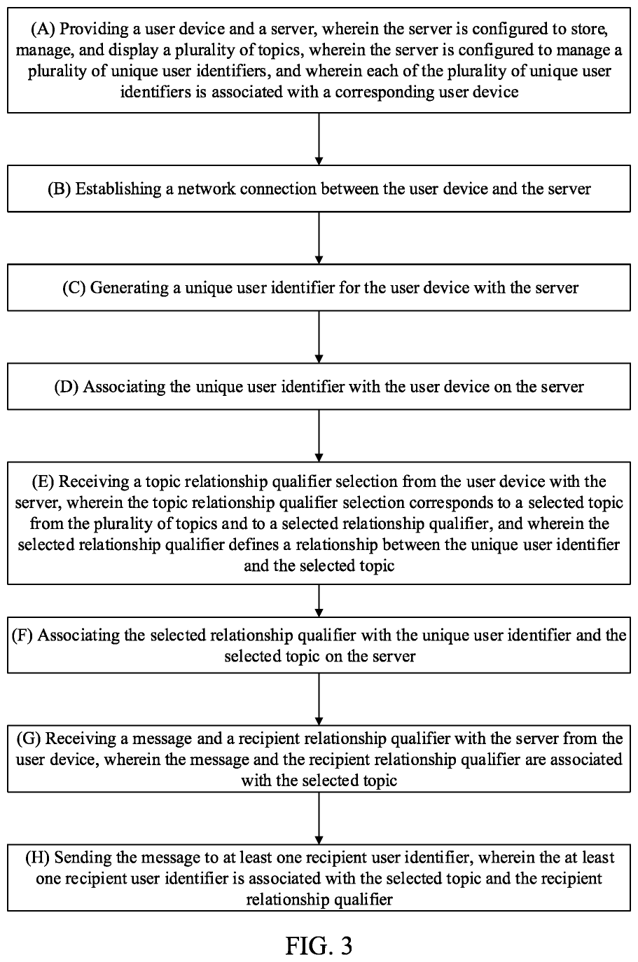

As shown in FIG. 3, in the general method of the present invention, a user device and a server are provided (Step A). The server is configured to store, manage, and display a plurality of topics, and the server is further configured to manage a plurality of unique user identifiers, wherein each of the plurality of unique user identifiers is associated with a corresponding user device. In some embodiments, each of the plurality of topics may comprise at least one category attribute. It is to be noted herein that displaying a topic or other item refers to displaying the item on a digital display device of the user device. Users may navigate through the hierarchical structure of topics displayed on the digital display device of their user device and select various means of interaction with the topics while being displayed the topic titles, their content, and/or other content items associated with the topics. It may be noted herein that references to unique user identifiers may be used interchangeably with a user profile, credentials, or other information associated with a given user device. Thus, references to unique user identifiers herein may in some cases be considered to represent a user profile, as opposed to simply the unique string of characters used to identify the user device.

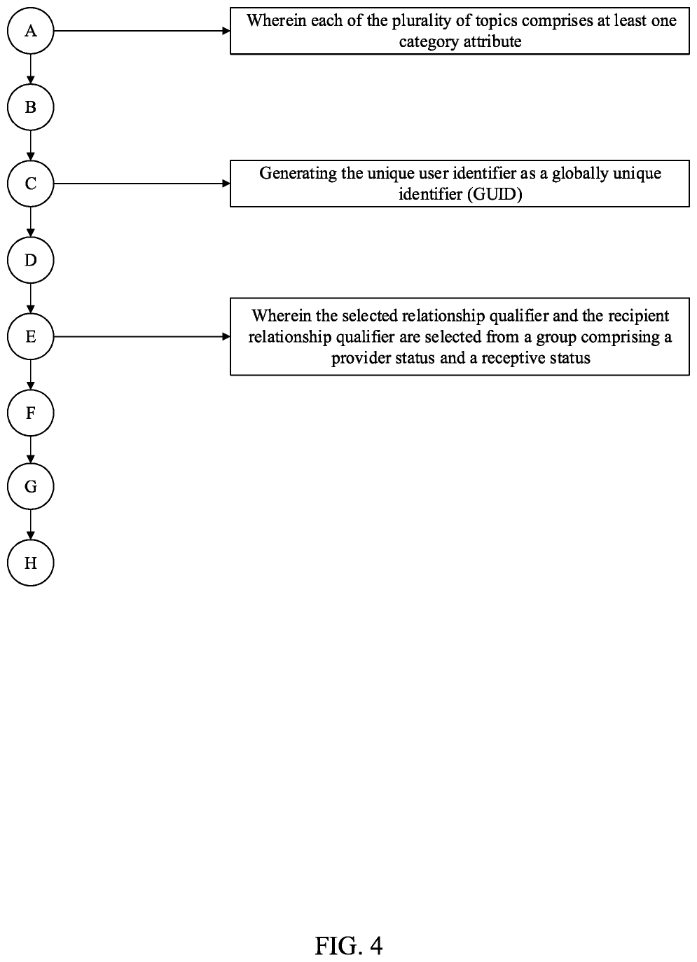

A network connection is first established between the user device and the server (Step B). Then, a unique user identifier is generated for the user device with the server (Step C) and the unique user identifier is associated with the user device on the server (Step D). In the preferred embodiment of the present invention, the unique user identifier is generated as a globally unique identifier (GUID), as shown in FIG. 4. In various embodiments, the GUID may be generated according to any desired and/or relevant algorithm. For example, the GUID may be generated based on one or more of any number of factors that are transmittable from the user device and/or receivable by the server, such as, but not limited to, IP address, web browser type, version or attributes, hardware characteristics of the user device, or other relevant factors. In some embodiments, the GUID is generated only once from the attributes of the user device the first time the user device connects to the server. The GUID may then be stored on the user device, in some embodiments as a cookie or other aspect, and the GUID may further be stored on the server and associated with the characteristics of the user device.

Once the user device is in communication with the server, a topic relationship qualifier selection may be received from the user device with the server (Step E), wherein the topic relationship qualifier selection corresponds to a selected topic from the plurality of topics and to a selected relationship qualifier, wherein the selected relationship qualifier defines a relationship between the unique user identifier and the selected topic. The selected relationship qualifier is then associated with the unique user identifier and the selected topic on the server (Step F). In some embodiments, the selected relationship qualifier and the recipient relationship qualifier may be selected from a group comprising a provider status and a receptive status. In various embodiments, however, the nature of the selected relationship qualifier may vary. For example, relationship qualifiers may be selected from a group comprising a like status and a dislike status, or a buyer status and a seller status. Relationship qualifiers between users and topics may vary in nature, and may be permanent or temporary, and may be employed in combination. Relationship qualifiers in the present invention define relationships and roles between users and topics. Users may be able to alter their roles at any time in some embodiments.

A message and a recipient relationship qualifier may be subsequently received with the server from the user device, wherein the message and the recipient relationship qualifier are associated with the selected topic (Step G). The message may then be sent to at least one recipient user identifier, wherein the at least one recipient user identifier is associated with the selected topic and the recipient relationship qualifier (Step H).

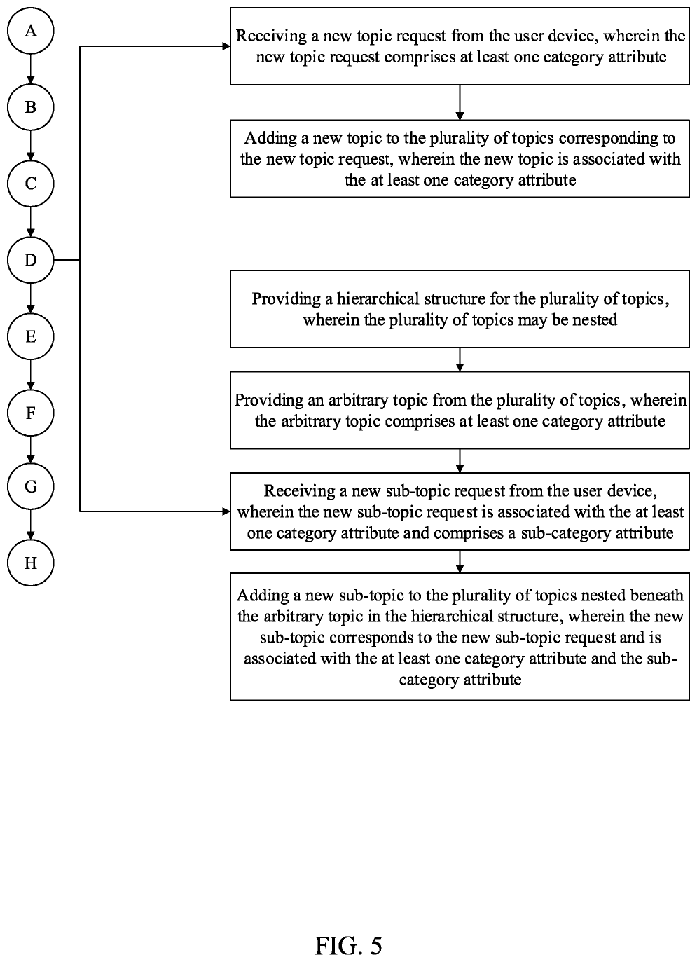

Referring to FIG. 5, in some embodiments, users will be able to create new topics to be added to the plurality of topics. In such cases, a new topic request may be received from the user device, wherein the new topic request comprises at least one category attribute. Then, a new topic is added to the plurality of topics corresponding to the new topic request, wherein the new topic is associated with the at least one category attribute. In some embodiments, any user of the present invention may be able to create new topics. In some embodiments, users may be required to possess certain privileges, permissions, or credentials associated with their unique user identifier in order to create new sub-topics. In some embodiments, new topic requests may be required to be reviewed before being added to the plurality of topics by an administrator user or other designated class of user with topic creation review permissions, credentials or other relevant status.

In some embodiments, the plurality of topics may be organized to have a hierarchical structure, wherein topic may be nested in various configurations and to various degrees. Thus, providing an arbitrary topic from the plurality of topics, wherein the arbitrary topic comprises at least one category attribute, a new sub-topic request may be received from the user device or any corresponding user device of one of the plurality of unique user identifiers, such that the new sub-topic request is associated with the at least one category attribute and comprises a sub-category attribute. For example, the category attribute of the arbitrary topic may be “Automotive,” and the sub-category attribute of the new sub-topic request may be “Vintage cars.” A new sub-topic is then added to the plurality of topics nested beneath the arbitrary topic in the hierarchical structure, wherein the new sub-topic corresponds to the new sub-topic request and is associated with the at least one category attribute and the sub-category attribute. Similar to topics, in some embodiments, any user of the present invention may be able to create new sub-topics. In some embodiments, users may be required to possess certain privileges, permissions, or credentials associated with their unique user identifier in order to create new sub-topics. In some embodiments, new sub-topic requests may be required to be reviewed before being added to the plurality of topics by an administrator user or other designated class of user with topic creation review permissions, credentials or other relevant status.

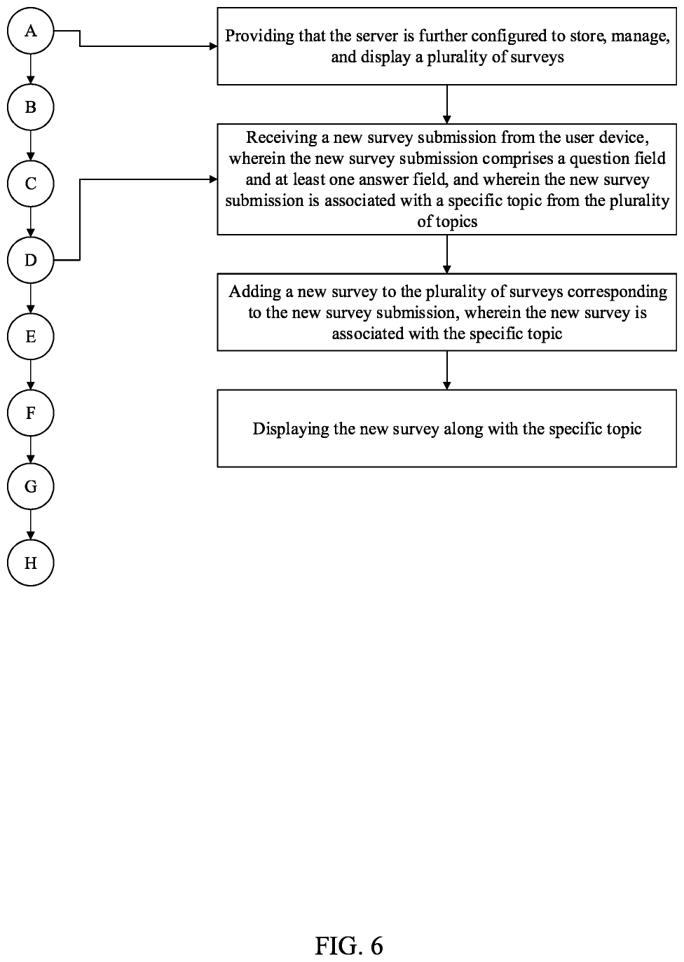

Various embodiments of the present invention may include various features enabled by the core functionality of the present invention. In some embodiments, referring to FIG. 6, the server may be further configured to store, manage, and display a plurality of surveys. A new survey submission may be received from the user device, wherein the new survey submission may comprise a question field and at least one answer field, and wherein the new survey submission may be associated with a specific topic from the plurality of topics. A new survey may then be added to the plurality of surveys, wherein the new survey corresponds to the new survey submission, and wherein the new survey is associated with the specific topic. The new survey may then be displayed along with the specific topic.

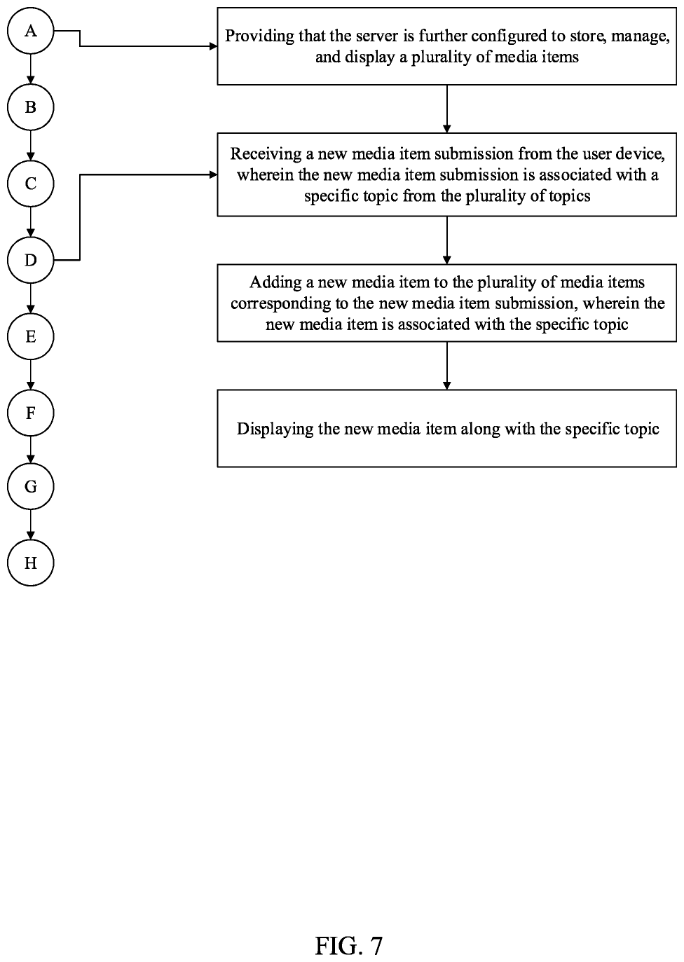

In some embodiments, the server may be further configured to store, manage, and display a plurality of media items, as described in FIG. 7. Thus, a new media item submission may be received from the user device, wherein the new media item submission is associated with a specific topic from the plurality of topics. A new media item may then be added to the plurality of media items, wherein the new media item corresponds to the new media item submission, and wherein the new media item is associated with the specific topic. The new media item may then be displayed along with the specific topic or in other relevant or desired contexts.

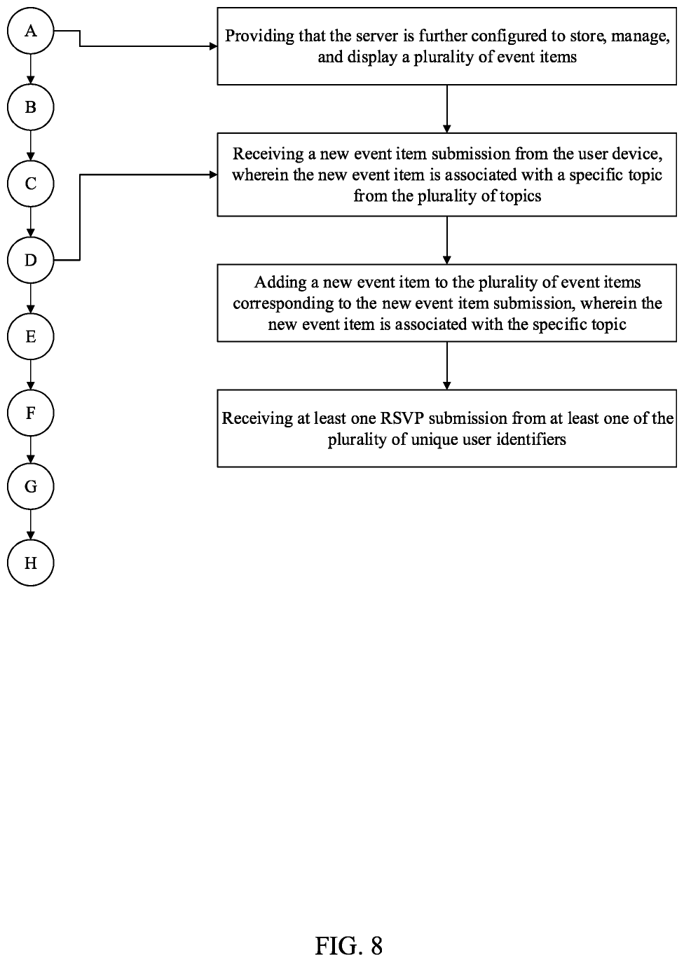

In some embodiments, the server may be further configured to store, manage, and display a plurality of event items, as described in FIG. 8. Thus, a new event item submission may be received from the user device, wherein the new event item is associated with a specific topic from the plurality of topics. For example, a new event item titled “Movie in the Park” may be associated with a topic of “Social events,” which may itself be a sub-topic of “Township Neighborhood.” A new event item may then be added to the plurality of event items, wherein the new event item corresponds to the new event item submission, and wherein the new event item is associated with the specific topic, in addition to being associated with any topics higher than the specific topic in the hierarchical structure of topics. Furthermore, users may be able to RSVP to event items in addition to any other desired functions such as, but not limited to, adding comments, pictures, videos or other content to event items. Thus, at least one RSVP submission may be received from at least one of the plurality of unique user identifiers.

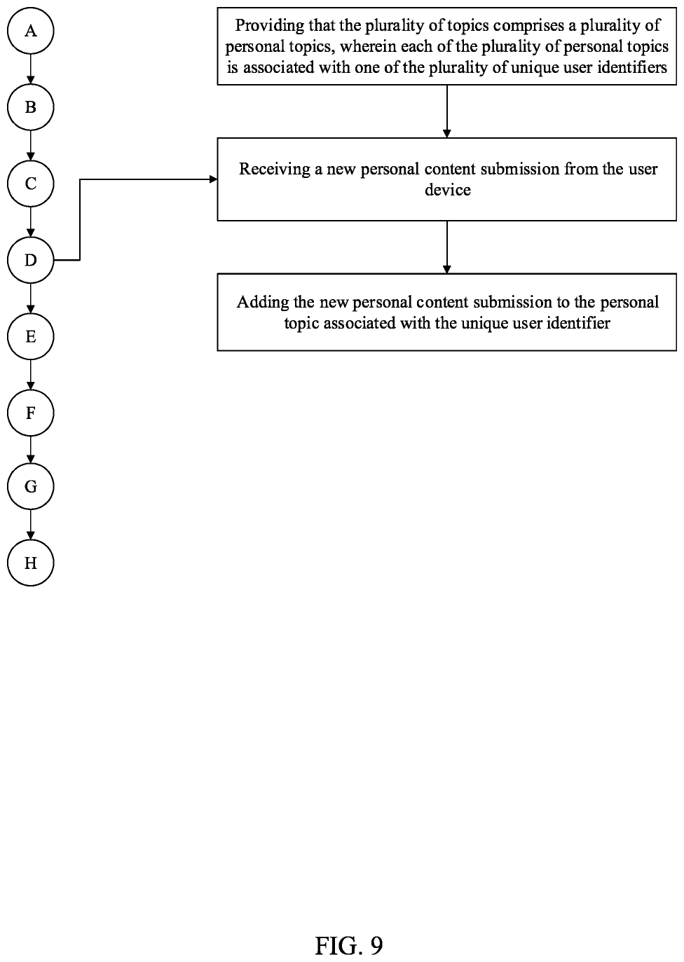

Referring to FIG. 9, furthermore, in some embodiments, each user may be provided with their own personal topic, which may function as a personal user profile page, weblog, or other similar feature. Thus, the plurality of topics may comprise a plurality of personal topics, wherein each of the plurality of personal topics is associated with one of the plurality of unique user identifiers. Each unique user identifier may have varying levels of control over their personal topic and may add or remove various elements to their personal topic as desired. Other users may be able to add comments or otherwise interact with personal topics. Thus, a new personal content submission may be received from the user device, and the new personal content submission is then added to the personal topic associated with the unique user identifier. Personal content submissions may comprise, but are not limited to, text, images, audio, videos, event items, digital games, widgets, or other items or features.

Although the invention has been explained in relation to its preferred embodiment, it is to be understood that many other possible modifications and variations can be made without departing from the spirit and scope of the invention as hereinafter claimed.

What is claimed is:

1. A method of implementing a topic based social media network comprises the steps of:
(A) providing a user device and a server,
wherein the server is configured to store, manage, and display a plurality of topics,
wherein the server is configured to manage a plurality of unique user identifiers, and
wherein each of the plurality of unique user identifiers is associated with a corresponding user device;
(B) establishing a network connection between the user device and the server;
(C) generating a unique user identifier for the user device with the server;
(D) associating the unique user identifier with the user device on the server;
(E) receiving a topic relationship qualifier selection from the user device with the server,
wherein the topic relationship qualifier selection corresponds to a selected topic from the plurality of topics and to a selected relationship qualifier, and
wherein the selected relationship qualifier defines a relationship between the unique user identifier and the selected topic;
(F) associating the selected relationship qualifier with the unique user identifier and the selected topic on the server;
(G) receiving a message and a recipient relationship qualifier with the server from the user device, wherein the message and the recipient relationship qualifier are associated with the selected topic; and
(H) sending the message to at least one recipient user identifier, wherein the at least one recipient user identifier is associated with the selected topic and the recipient relationship qualifier.

2. The method of implementing a topic based social media network as claimed in claim 1 comprises the steps of:
generating the unique user identifier as a globally unique identifier (GUID).

3. The method of implementing a topic based social media network as claimed in claim 1, wherein the selected relationship qualifier and the recipient relationship qualifier are selected from a group comprising a provider status and a receptive status.

4. The method of implementing a topic based social media network as claimed in claim 1, wherein each of the plurality of topics comprises at least one category attribute.

5. The method of implementing a topic based social media network as claimed in claim 1 comprises the steps of:
receiving a new topic request from the user device, wherein the new topic request comprises at least one category attribute; and
adding a new topic to the plurality of topics corresponding to the new topic request, wherein the new topic is associated with the at least one category attribute.

6. The method of implementing a topic based social media network as claimed in claim 1 comprises the steps of:
providing a hierarchical structure for the plurality of topics, wherein the plurality of topics may be nested;
providing an arbitrary topic from the plurality of topics, wherein the arbitrary topic comprises at least one category attribute;
receiving a new sub-topic request from the user device, wherein the new sub-topic request is associated with the at least one category attribute and comprises a sub-category attribute; and
adding a new sub-topic to the plurality of topics nested beneath the arbitrary topic in the hierarchical structure, wherein the new sub-topic corresponds to the new sub-topic request and is associated with the at least one category attribute and the sub-category attribute.

7. The method of implementing a topic based social media network as claimed in claim 1 comprises the steps of:
providing that the server is further configured to store, manage, and display a plurality of surveys;
receiving a new survey submission from the user device, wherein the new survey submission comprises a question field and at least one answer field, and wherein the new survey submission is associated with a specific topic from the plurality of topics;
adding a new survey to the plurality of surveys corresponding to the new survey submission, wherein the new survey is associated with the specific topic; and
displaying the new survey along with the specific topic.

8. The method of implementing a topic based social media network as claimed in claim 1 comprises the steps of:
providing that the server is further configured to store, manage, and display a plurality of media items;
receiving a new media item submission from the user device, wherein the new media item submission is associated with a specific topic from the plurality of topics;
adding a new media item to the plurality of media items corresponding to the new media item submission, wherein the new media item is associated with the specific topic; and
displaying the new media item along with the specific topic.

9. The method of implementing a topic based social media network as claimed in claim 1 comprises the steps of:
providing that the server is further configured to store, manage, and display a plurality of event items;
receiving a new event item submission from the user device, wherein the new event item is associated with a specific topic from the plurality of topics;
adding a new event item to the plurality of event items corresponding to the new event item submission, wherein the new event item is associated with the specific topic; and
receiving at least one RSVP submission from at least one of the plurality of unique user identifiers.

10. The method of implementing a topic based social media network as claimed in claim 1 comprises the steps of:
providing that the plurality of topics comprises a plurality of personal topics, wherein each of the plurality of personal topics is associated with one of the plurality of unique user identifiers;
receiving a new personal content submission from the user device; and
adding the new personal content submission to the personal topic associated with the unique user identifier.
